(19) United States
(12) Patent Application Publication
(10) Pub. No.: US 2024/0199088 A1
(43) Pub. Date: Jun. 20, 2024

(54) SYSTEMS AND METHODS FOR ADAPTING AUTONOMOUS DRIVING ESCALATION STRATEGIES

(71) Applicant: GM GLOBAL TECHNOLOGY OPERATIONS LLC, Detroit, MI (US)

(72) Inventors: Parisa Mahvelatishamsabadi, North york (CA); Milad Jalaliyazdi, Richmond Hill (CA); Zhi Li, Unionville (CA); Mohammadali Shahriari, Markham (CA); Peitong Hu, Markham (CA); Kin Man Michael Wong, Thornhill (CA)

(73) Assignee: GM GLOBAL TECHNOLOGY OPERATIONS LLC, Detroit, MI (US)

(21) Appl. No.: 18/066,994

(22) Filed: Dec. 15, 2022

(51) Int. Cl. B60W 60/00; B60W 50/14

(52) U.S. Cl. CPC B60W 60/0053; B60W 50/14; B60W 2540/229; B60W 2552/05; B60W 2552/30; B60W 2554/40; B60W 2555/20; B60W 2556/10

(57) ABSTRACT

Methods and systems are provided for alerting a driver to take control of a vehicle. In one embodiment, a method includes: determining, by a processor, a driver alertness level based on a weighted summation of a first set of feature data; determining, by the processor, a required alertness level based on a weighted summation of a second set of feature data; determining, by the processor, an escalation index based on the driver alertness level and the required alertness level; and generating, by the processor, alert notification data based on the escalation index.

### INTRODUCTION

The technical field generally relates to autonomous control systems, and more particularly relates to autonomous driving escalation strategies between autonomous driving and driver intervention.

An autonomous vehicle is a vehicle that is capable of sensing its environment and navigating with little or no user input. An autonomous vehicle senses its environment using sensing devices such as radar, lidar, image sensors, and the like. The autonomous vehicle system further uses information from global positioning systems (GPS) technology, navigation systems, vehicle-to-vehicle communication, vehicle-to-infrastructure technology, and/or drive-by-wire systems to navigate the vehicle.

Vehicle automation has been categorized into numerical levels ranging from Zero, corresponding to no automation with full human control, to Five, corresponding to full automation with no human control. Various automated driver-assistance systems, such as cruise control, adaptive cruise control, and parking assistance systems correspond to lower automation levels, while true “driverless” vehicles correspond to higher automation levels.

Many autonomous driving features require a driver to be present and to remain engaged and take back control when necessary. Managing the transition from autonomous control to driver control can be performed using escalation strategies. Current escalation strategies use a one-size fits all approach for all driving scenarios. In such cases, the timing used in the escalation strategies may cause dissatisfaction to a driver.

Accordingly, it is desirable to provide improved escalation strategies, methods, and systems. Furthermore, other desirable features and characteristics of the present disclosure will become apparent from the subsequent detailed description and the appended claims, taken in conjunction with the accompanying drawings and the foregoing technical field and background.

### SUMMARY

Methods and systems are provided for alerting a driver to take control of a vehicle. In one embodiment, a method includes: determining, by a processor, a driver alertness level based on a weighted summation of a first set of feature data; determining, by the processor, a required alertness level based on a weighted summation of a second set of feature data; determining, by the processor, an escalation index based on the driver alertness level and the required alertness level; and generating, by the processor, alert notification data based on the escalation index.

In various embodiments, the determining the escalation index comprises comparing the driver alertness level with the required alertness level, and when the driver alertness level falls below the required alertness level, determining the escalation index based on a deficiency in the driver alertness level.

The In various embodiments, the escalation index includes an escalation pace of notifying the driver via the alert notification data.

In various embodiments, the method incudes determining a weight associated with each feature of the feature data, and wherein the determining the driver alertness level is based on the weights.

In various embodiments, the determining the weight is based on a trained classification model stored in a data storage device of the vehicle.

In various embodiments, the method further includes training the classification model based on a normalization of feature data associated with various vehicle events deemed to be risky with respect to a baseline distribution to establish a relative importance of features of the vehicle events.

In various embodiments, the determining the weight is based on predetermined weights stored in a data storage device of the vehicle.

In various embodiments, the first set of feature data includes at least one of a surrounding traffic, a number of intersections, a road lane quality, a road lane curvature, a weather condition, and wind speed.

In various embodiments, the first set of feature data includes at least one of a steering tracking error, a target lane tracking error, a steering busyness, a lane touch count, and an inertia measurement unit bias.

In various embodiments, the second set of feature data includes at least one of a driver's hand position, a driver attention level, a driver reaction delay, and an escalation history.

In another embodiment, a system includes: a non-transitory computer readable media encoded with programming instructions configured to, by a processor, determine a driver alertness level based on a weighted summation of a first set of feature data; determine a required alertness level based on a weighted summation of a second set of feature data; determine an escalation index based on the driver alertness level and the required alertness level; and generate alert notification data based on the escalation index.

In various embodiments, the programming instructions are configured to determine the escalation index by comparing the driver alertness level with the required alertness level, and when the driver alertness level falls below the required alertness level, determine the escalation index based on a deficiency in the driver alertness level.

In various embodiments, the escalation index includes an escalation pace of notifying the driver via the alert notification data.

In various embodiments, the programming instructions are further configured to determine a weight associated with each feature of the feature data, and determine the driver alertness level based on the weights.

In various embodiments, the programming instructions determine the weight based on a trained classification model stored in a data storage device of the vehicle.

In various embodiments, the programming instructions are further configured to train the classification model based on a normalization of feature data associated with various vehicle events deemed to be risky with respect to a baseline distribution to establish a relative importance of features of the vehicle events.

In various embodiments, the programming instructions are configured to determine the weight based on predetermined weights stored in a data storage device of the vehicle.

In various embodiments, the first set of feature data includes at least one of a surrounding traffic, a number of intersections, a road lane quality, a road lane curvature, a weather condition, and wind speed.

In various embodiments, the first set of feature data includes at least one of a steering tracking error, a target lane tracking error, a steering busyness, a lane touch count, and an inertia measurement unit bias.

In various embodiments, the second set of feature data includes at least one of a driver's hand position, a driver attention level, a driver reaction delay, and an escalation history.

### BRIEF DESCRIPTION OF THE DRAWINGS

The exemplary embodiments will hereinafter be described in conjunction with the following drawing figures, wherein like numerals denote like elements, and wherein:

FIG. 1 is a block diagram illustrating an autonomous vehicle having an escalation system in accordance with various embodiments;

FIG. 2 is a functional block diagram illustrating features of an autonomous driving system of the autonomous vehicle in accordance with various embodiments;

FIG. 3 is a dataflow diagram illustrating features of the escalation system of the autonomous driving system in accordance with various embodiments;

FIG. 4 is a graph illustrating sample alertness values over time as predicted by the escalation system in accordance with various embodiments; and

FIGS. 5 and 6 are process flow charts depicting example processes for escalation in accordance with various embodiments.

### DETAILED DESCRIPTION

The following detailed description is merely exemplary in nature and is not intended to limit the application and uses. Furthermore, there is no intention to be bound by any expressed or implied theory presented in the preceding technical field, background, summary, or the following detailed description. As used herein, the term “module” refers to any hardware, software, firmware, electronic control component, processing logic, and/or processor device, individually or in any combination, including without limitation: application specific integrated circuit (ASIC), a field-programmable gate-array (FPGA), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of systems, and that the systems described herein is merely exemplary embodiments of the present disclosure.

For the sake of brevity, conventional techniques related to signal processing, data transmission, signaling, control, machine learning models, radar, lidar, image analysis, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

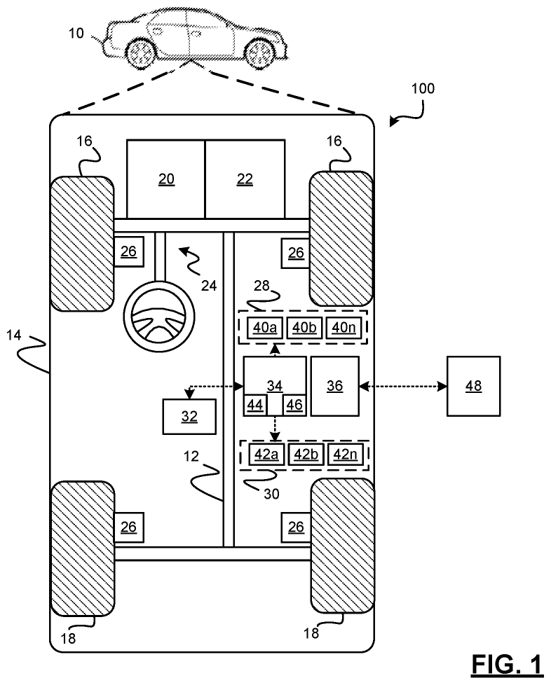

With reference to FIG. 1, an escalation system shown generally at 100 is associated with a vehicle 10 in accordance with various embodiments. In general, the escalation system 100 manages the transition from operation of an autonomous driving feature where the vehicle 10 is controlling operation of the vehicle 10, to driver control where the driver steps in to control operation of the vehicle 10. In various embodiments, the escalation system 100 manages the transition based on an estimate that quantifies the driver's cognitive attention and an estimate that quantifies the required attention over different static and dynamic scenarios. In various embodiments, the estimates are compared in order to intelligently configure escalation timing parameters such that the transition is robust while maximizing the driver's safety and improving the driver's experience.

As depicted in FIG. 1, the vehicle 10 generally includes a chassis 12, a body 14, front wheels 16, and rear wheels 18. The body 14 is arranged on the chassis 12 and substantially encloses components of the vehicle 10. The body 14 and the chassis 12 may jointly form a frame. The wheels 16-18 are each rotationally coupled to the chassis 12 near a respective corner of the body 14.

In various embodiments, the vehicle 10 is an autonomous vehicle and the escalation system 100 is incorporated into the autonomous vehicle 10 (hereinafter referred to as the autonomous vehicle 10). The autonomous vehicle 10 is, for example, a vehicle that is automatically controlled to carry passengers from one location to another. The vehicle 10 is depicted in the illustrated embodiment as a passenger car, but it should be appreciated that any other vehicle including motorcycles, trucks, sport utility vehicles (SUVs), recreational vehicles (RVs), marine vessels, aircraft, etc., can also be used. In an exemplary embodiment, the autonomous vehicle 10 is configured to perform autonomous features such as, but not limited to, hands on lane centering assist, path-based lane keep assist, super cruise, ultra-cruise, etc.

As shown, the autonomous vehicle 10 generally includes a propulsion system 20, a transmission system 22, a steering system 24, a brake system 26, a sensor system 28, an actuator system 30, at least one data storage device 32, at least one controller 34, and a communication system 36. The propulsion system 20 may, in various embodiments, include an internal combustion engine, an electric machine such as a traction motor, and/or a fuel cell propulsion system. The transmission system 22 is configured to transmit power from the propulsion system 20 to the vehicle wheels 16-18 according to selectable speed ratios. According to various embodiments, the transmission system 22 may include a step-ratio automatic transmission, a continuously-variable transmission, or other appropriate transmission. The brake system 26 is configured to provide braking torque to the vehicle wheels 16-18. The brake system 26 may, in various embodiments, include friction brakes, brake by wire, a regenerative braking system such as an electric machine, and/or other appropriate braking systems. The steering system 24 influences a position of the of the vehicle wheels 16-18.

The sensor system 28 includes one or more sensing devices 40a-40n that sense observable conditions of the exterior environment and/or the interior environment of the autonomous vehicle 10. The sensing devices 40a-40n can include, but are not limited to, radars, lidars, global positioning systems, optical cameras, thermal cameras, ultrasonic sensors, and/or other sensors. The actuator system 30 includes one or more actuator devices 42a-42n that control one or more vehicle features such as, but not limited to, the propulsion system 20, the transmission system 22, the steering system 24, and the brake system 26. In various embodiments, the vehicle features can further include interior and/or exterior vehicle features such as, but are not limited to, doors, a trunk, and cabin features such as air, music, lighting, etc. (not numbered).

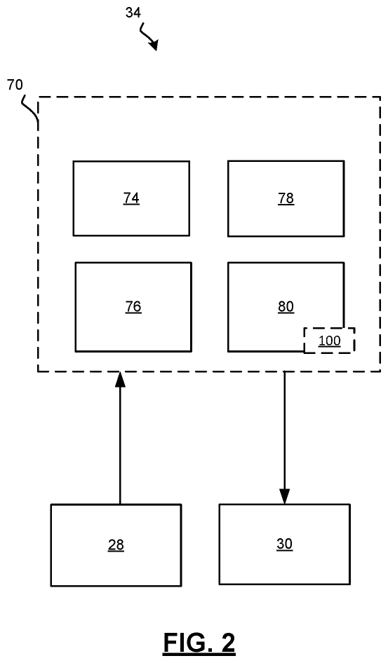

The communication system 36 is configured to wirelessly communicate information to and from other entities 48, such as but not limited to, other vehicles (“V2V” communication,) infrastructure (“V2I” communication), remote systems, and/or personal devices (described in more detail with regard to FIG. 2). In an exemplary embodiment, the communication system 36 is a wireless communication system configured to communicate via a wireless local area network (WLAN) using IEEE 802.11 standards or by using cellular data communication. However, additional, or alternate communication methods, such as a dedicated short-range communications (DSRC) channel, are also considered within the scope of the present disclosure. DSRC channels refer to one-way or two-way short-range to medium-range wireless communication channels specifically designed for automotive use and a corresponding set of protocols and standards.

The data storage device 32 stores data for use in automatically controlling the autonomous vehicle 10. In various embodiments, the data storage device 32 stores defined maps of the navigable environment. In various embodiments, the defined maps may be predefined by and obtained from a remote system. For example, the defined maps may be assembled by the remote system and communicated to the autonomous vehicle 10 (wirelessly and/or in a wired manner) and stored in the data storage device 32. As can be appreciated, the data storage device 32 may be part of the controller 34, separate from the controller 34, or part of the controller 34 and part of a separate system.

The controller 34 includes at least one processor 44 and a computer readable storage device or media 46. The processor 44 can be any custom made or commercially available processor, a central processing unit (CPU), a graphics processing unit (GPU), an auxiliary processor among several processors associated with the controller 34, a semiconductor based microprocessor (in the form of a microchip or chip set), a macroprocessor, any combination thereof, or generally any device for executing instructions. The computer readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the processor 44 is powered down. The computer-readable storage device or media 46 may be implemented using any of a number of known memory devices such as PROMs (programmable read-only memory), EPROMS (electrically PROM), EEPROMs (electrically erasable PROM), flash memory, or any other electric, magnetic, optical, or combination memory devices capable of storing data, some of which represent executable instructions, used by the controller 34 in controlling the autonomous vehicle 10.

The instructions may include one or more separate programs, each of which comprises an ordered listing of executable instructions for implementing logical functions. The instructions, when executed by the processor 44, receive and process signals from the sensor system 28, perform logic, calculations, methods and/or algorithms for automatically controlling the components of the autonomous vehicle 10, and generate control signals to the actuator system 30 to automatically control the components of the autonomous vehicle 10 based on the logic, calculations, methods, and/or algorithms. Although only one controller 34 is shown in FIG. 1, embodiments of the autonomous vehicle 10 can include any number of controllers 34 that communicate over any suitable communication medium or a combination of communication mediums and that cooperate to process the sensor signals, perform logic, calculations, methods, and/or algorithms, and generate control signals to automatically control features of the autonomous vehicle 10.

In various embodiments, as discussed in detail below, one or more instructions of the controller 34 are embodied in the escalation system 100 and, when executed by the processor 44, process sensor data and/or other data, compute an estimate that quantifies the driver's cognitive attention over different static and dynamic scenarios, compute an estimate that quantifies the required attention over different static and dynamic, and compare the estimates in order to intelligently configure escalation timing parameters in order to alert a driver and/or control the vehicle 10.

Referring now to FIG. 2, and with continued reference to FIG. 1, a dataflow diagram illustrates various embodiments of an autonomous driving system (ADS) 70 which may be embedded within the controller 34 and which may include parts of the escalation system 100 in accordance with various embodiments. That is, suitable software and/or hardware components of controller 34 (e.g., processor 44 and computer-readable storage device 46) are utilized to provide an autonomous driving system 70 that is used in conjunction with vehicle 10.

Inputs to the autonomous driving system 70 may be received from the sensor system 28, received from other control modules (not shown) associated with the autonomous vehicle 10, received from the communication system 36, and/or determined/modeled by other sub-modules (not shown) within the controller 34. In various embodiments, the instructions of the autonomous driving system 70 may be organized by function or system. For example, as shown in FIG. 2, the autonomous driving system 70 can include a computer vision system 74, a positioning system 76, a guidance system 78, and a vehicle control system 80. As can be appreciated, in various embodiments, the instructions may be organized into any number of systems (e.g., combined, further partitioned, etc.) as the disclosure is not limited to the present examples.

In various embodiments, the computer vision system 74 synthesizes and processes sensor data and predicts the presence, location, classification, and/or path of objects and features of the environment of the vehicle 10. In various embodiments, the computer vision system 74 can incorporate information from multiple sensors, including but not limited to, cameras, lidars, radars, and/or any number of other types of sensors.

The positioning system 76 processes sensor data along with other data to determine a position (e.g., a local position relative to a map, an exact position relative to lane of a road, vehicle heading, velocity, etc.) of the vehicle 10 relative to the environment. The guidance system 78 processes sensor data along with other data to determine a path for the vehicle 10 to follow. The vehicle control system 80 generates control signals for controlling the vehicle 10 according to the determined path.

In various embodiments, the controller 34 implements machine learning techniques to assist the functionality of the controller 34, such as obstruction mitigation, route traversal, mapping, sensor integration, ground-truth determination, and feature detection, and object classification as discussed herein.

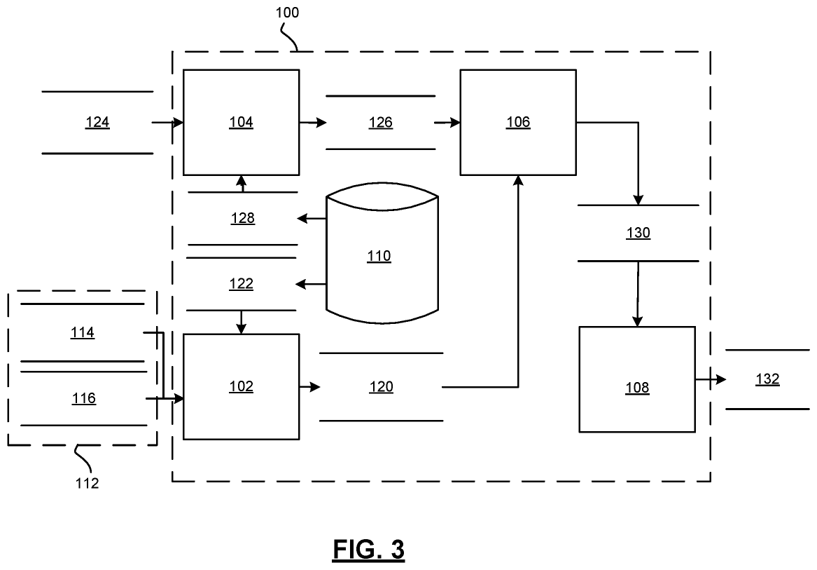

As mentioned briefly above, the escalation system 100 of FIG. 1 is included within the autonomous driving system 70. For example, all or parts of the escalation system 100 may be included within the vehicle control system 80. For example, as shown in more detail with regard to FIG. 3 and with continued reference to FIGS. 1 and 2, the escalation system 100 includes a required alertness determination module 102, a driver alertness determination module 104, an escalation index determination module 106, a notification module 108, and a weights data datastore 110.

In various embodiments, the required alertness determination module 102 determines a cognitive alertness required for a particular scenario (hereinafter referred to as a required alertness) in real-time using various available data inputs indicating the current scenario and generates required alertness data 120 based thereon. For example, the required alertness determination module 102 receives as input event data 112 including surrounding environment data 114 and feature/sensor data 116. In various embodiments, the surrounding environment data 114 indicates conditions of the surrounding environment and can include, but is not limited to, surrounding traffic (T_{S}), a number of intersections (Ni), a road lane quality (Q_{L}), a road lane curvature (ρ), weather conditions (1−μ), wind speed (V_{W}), etc. In various embodiments the feature/sensor data 118 indicates a status of the sensor information and/or features of the autonomous driving system 70 and can include, but is not limited to, steering tracking error (e_{S}), target lane tracking error (e_{LCC}), steering business (\dot{δ}), lane touch count (C_{L}), IMU bias (B_{IMU}), etc.

The required alertness determination module 102 determines a value for the required cognitive alertness based on a function of the surrounding environment data 114 and the feature/sensor data 116:

$${P}_{S E} = [ {T}_{S} , {N}_{I} , {Q}_{L} , {ρ}_{,} , 1 - μ , {V}_{W} , ]$$

$$and {P}_{DI} = [ {e}_{S} , {e}_{LCC} , {δ}_{h} {C}_{L} , {B}_{EIMU} , ] .$$

For example, the required cognitive alertness V_{RA} can be computed as:

$${V}_{R A} = {\sum }_{{t}_{c - {nT}_{s}}}^{{t}_{c}} {P}_{S E}^{T} {W}_{S E} {P}_{S E} + {P}_{S E}^{T} {W}_{F S} {P}_{F S} , \qquad ( 1 )$$

where W represents weights associated with each feature of the event and can be obtained from the weights data datastore 110, and P represents measurements associated with each feature of the event, and a look ahead traffic score computed from the traffic scenario surrounding the vehicle with any penalty weights applied.

In various embodiments, the driver alertness determination module 104 determines a driver's alertness level for a particular scenario in real-time using various available inputs. For example, the required alertness determination module 102 receives as input driver inattention data 124. The driver inattention data 124 can include, but is not limited to, a driver's hands-off percentage Pct_{HO}, a driver inattentiveness level I_{DMS}, a driver inattentiveness level I_{EPS}, a driver reaction delay t_{RD}, a hands on lane centering escalation frequency f_{E}, etc.

The driver alertness determination module 104 determines a value for the driver alertness based on a function of the driver inattention data 124:

$${P}_{DI} = [ P c {t}_{DIHO} , {I}_{DMS} , {I}_{EPS} , {t}_{RD} , {f}_{E} , ] .$$

For example, the driver alertness V_{DI} can be computed as a weighted combination of the driver inattention data:

$${V}_{DI} = {Σ}_{{t}_{c - {nT}_{s}}}^{{t}_{c}} {P}_{DI}^{T} {W}_{DI} {P}_{DI} , \qquad ( 2 )$$

where associated with each feature of the event and can be obtained from the weights data datastore 110, P represents measurements associated with each feature of the event, and T represents a look ahead traffic score computed from the traffic scenario surrounding the vehicle with any penalty weights applied.

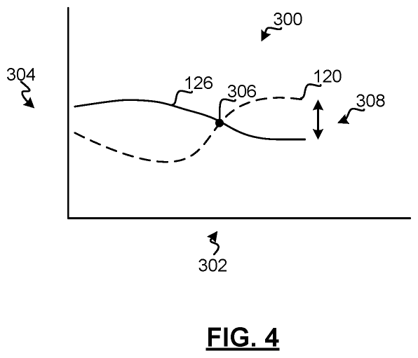

In various embodiments, the escalation index determination module 106 receives as input the required alertness data 120, and the driver alertness data 126. The escalation index determination module 106 determines an escalation index based on a comparison of the required alertness data 120 and the driver alertness data 126. For example, FIG. 4 illustrates exemplary values of required alertness data 120 and driver alertness data 126 plotted along a graph 300 defined by time on the x-axis 302 and cognitive alertness levels on the y-axis 304. When the driver alertness level is equal to (at point 306) and then falls below the required alertness level for a predefined amount of time, the escalation index determination module 106 determines an escalation index value used to determine the pace of escalation. In various embodiments, the escalation index determination module 106 computes the escalation index as a function of the attention deficiency (at 308). For example, the escalation index determination module 106 determines the index E as:

$$Q = {V}_{R A} - {V}_{D A} ,$$

$$E = \frac{{Q}^{2}}{{Q}_{m}} when \frac{d}{d t} ‖ Q ‖ > 0 ,$$

$$and E = {E}_{0} when \frac{d}{d t} ‖ Q ‖ < 0.$$

In various embodiments, the notification module 108 receives as input the escalation index data 130. The notification module 108 generates alert data 132 that is used to generate alert notifications to the driver. In various embodiments, the alert data 132 can include graphical and/or textual notifications to a driver to participate in control of the vehicle 10 via, for example, steering, braking, and/or accelerating.

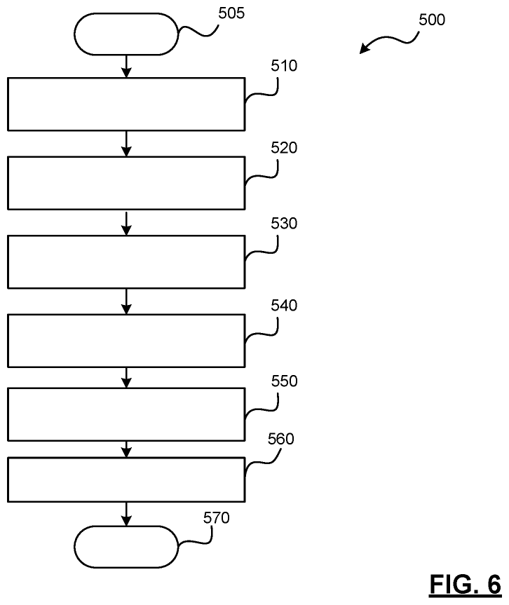

In various embodiments, the weights data datastore 110 stores the weight data 122, 128 used in determining the required alertness data 120 and the driver alertness data 126. The weight data can include, for example, predetermined weights associated with the various data inputs and/or a trained model for identifying the weights in real-time based on the data inputs. For example, a first model is trained to provide weights for the event data associated with the required alertness and a second model is trained to provide weights for the event data associated with the driver alertness. In various embodiments, the predetermined weights and trained model can be determined from event data obtained from a fleet of vehicles and associated with driving events deemed risky and using, for example, the process shown in FIG. 6.

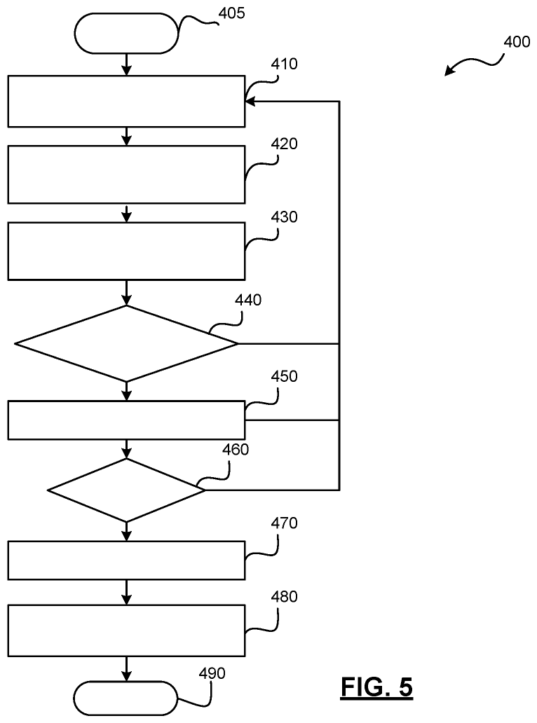

Referring now to FIGS. 5 and 6, and with continued reference to FIGS. 1-4, flowcharts illustrate a process 400 and a process 500 that can be performed by the escalation system 100 of FIG. 1 in accordance with the present disclosure. As can be appreciated in light of the disclosure, the order of operation within the processes 400, 500 is not limited to the sequential execution as illustrated in FIGS. 5 and 6, but may be performed in one or more varying orders as applicable and in accordance with the present disclosure. In various embodiments, the processes 400, 500 can be scheduled to run based on one or more predetermined events, and/or can run continuously during operation of the autonomous vehicle 10, and/or may be run offline prior to operation of the vehicle 10.

In one embodiment, the process 400 may begin at 405. Any and all available event data is received at 410. The required cognitive alertness is estimated in real-time using the any/all event data and the associated relative importance (weights), for example, using the relationship shown in equation (1) at 420. The driver's alertness level is estimated using the any/all event data and the relative importance (weights), for example, using the relationship shown in equation (2) at 430.

Thereafter, the required alertness and the driver's alertness are compared at 440. When the driver alertness is greater than the required alertness at 450, the process 400 continues with receiving new feature data at 410.

When the driver alertness falls below the required alertness at 440, a timer is initiated/incremented at 450. If the timer is below a timer threshold at 460, the process 400 continues with receiving new feature data at 410.

Once the timer is above the threshold time at 460, the escalation index is determined at 470 and the escalation index is used to generate the notification data including the alert to the driver at 480. Thereafter, the process 400 may end at 490.

In another embodiment, the process 500 may begin at 505. The event data from a variety of different events is collected from a fleet of vehicles at 510. A baseline distribution of the event data is collected from the fleet of vehicles at 520. The event data associated with various vehicle events deemed to be “risky” is normalized with respect to the baseline distribution at 530. A classification model such as, but not limited to, a random forest model, a support vector machine model, decision tree, a K nearest neighbor model, a logistics regression model, etc., that fits the features associated with the risky events is generated based thereon at 540. The relative importance of the features for each event is determined using the classification model at 550 and is stored for use. Optionally, the trained classification model is stored for real-time use at 560. Thereafter, the process 500 may end at 570.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method of alerting a driver to take control of a vehicle, comprising:
determining, by a processor, a driver alertness level based on a weighted summation of a first set of feature data;
determining, by the processor, a required alertness level based on a weighted summation of a second set of feature data;
determining, by the processor, an escalation index based on the driver alertness level and the required alertness level; and
generating, by the processor, alert notification data based on the escalation index.

2. The method of claim 1, wherein the determining the escalation index comprises comparing the driver alertness level with the required alertness level, and when the driver alertness level falls below the required alertness level, determining the escalation index based on a deficiency in the driver alertness level.

3. The method of claim 1, wherein the escalation index includes an escalation pace of notifying the driver via the alert notification data.

4. The method of claim 1, further comprising determining a weight associated with each feature of the feature data, and wherein the determining the driver alertness level is based on the weights.

5. The method of claim 4, wherein the determining the weight is based on a trained classification model stored in a data storage device of the vehicle.

6. The method of claim 5, further comprising training the classification model based on a normalization of feature data associated with various vehicle events deemed to be risky with respect to a baseline distribution to establish a relative importance of features of the vehicle events.

7. The method of claim 4, wherein the determining the weight is based on predetermined weights stored in a data storage device of the vehicle.

8. The method of claim 1, wherein the first set of feature data includes at least one of a surrounding traffic, a number of intersections, a road lane quality, a road lane curvature, a weather condition, and wind speed.

9. The method of claim 1, wherein the first set of feature data includes at least one of a steering tracking error, a target lane tracking error, a steering busyness, a lane touch count, and an inertia measurement unit bias.

10. The method of claim 1, wherein the second set of feature data includes at least one of a driver's hand position, a driver attention level, a driver reaction delay, and an escalation history.

11. A system for alerting a driver of a vehicle, comprising:
a non-transitory computer readable media encoded with programming instructions configured to, by a processor,
determine a driver alertness level based on a weighted summation of a first set of feature data;
determine a required alertness level based on a weighted summation of a second set of feature data;
determine an escalation index based on the driver alertness level and the required alertness level; and
generate alert notification data based on the escalation index.

12. The system of claim 11, wherein the programming instructions are configured to determine the escalation index by comparing the driver alertness level with the required alertness level, and when the driver alertness level falls below the required alertness level, determine the escalation index based on a deficiency in the driver alertness level.

13. The system of claim 11, wherein the escalation index includes an escalation pace of notifying the driver via the alert notification data.

14. The system of claim 11, wherein the programming instructions are further configured to determine a weight associated with each feature of the feature data, and determine the driver alertness level based on the weights.

15. The system of claim 14, wherein the programming instructions determine the weight based on a trained classification model stored in a data storage device of the vehicle.

16. The system of claim 15, wherein the programming instructions are further configured to train the classification model based on a normalization of feature data associated with various vehicle events deemed to be risky with respect to a baseline distribution to establish a relative importance of features of the vehicle events.

17. The system of claim 14, wherein the programming instructions are configured to determine the weight based on predetermined weights stored in a data storage device of the vehicle.

18. The system of claim 11, wherein the first set of feature data includes at least one of a surrounding traffic, a number of intersections, a road lane quality, a road lane curvature, a weather condition, and wind speed.

19. The system of claim 11, wherein the first set of feature data includes at least one of a steering tracking error, a target lane tracking error, a steering busyness, a lane touch count, and an inertia measurement unit bias.

20. The system of claim 11, wherein the second set of feature data includes at least one of a driver's hand position, a driver attention level, a driver reaction delay, and an escalation history.
